(19) United States
(12) Patent Application Publication
(10) Pub. No.: US 2006/0055510 A1
(43) Pub. Date: Mar. 16, 2006

(54) Access control

(75) Inventors: Anthony Russell Little, Parkdale (AU); Paul Anthony Hogan, Bentleigh East (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Australian Arrow Pty Ltd., Carrum Downs, Victoria (AU)

(21) Appl. No.: 10/545,012

(22) PCT Filed: Feb. 24, 2004
(86) PCT No.: PCT/AU04/00231

§ 371 Date: Aug. 9, 2005

(30) Foreign Application Priority Data
Feb. 25, 2003 (AU) 2003900842
Dec. 23, 2003 (AU) 2003907154

(51) Int. Cl. G05B 19/00

(52) U.S. Cl. 340/5.62; 340/5.72

(57) ABSTRACT

An access control system for controlling access to a restricted area or space using proximity detection of a portable control unit has a manually operated switch (18) that operates in conjunction with the proximity detection. When a control unit is sensed within range of a detection means, the switch is enabled so that subsequent actuation facilitates entry to the area or space. The space may be the interior of a vehicle, and the access control is a door (20) with a handle (12), movement of which in a defined direction operates the switch (18) to allow the door (20) to be opened by the handle (12). The switch (18) can also be used to lock the door (12).

### FIELD OF THE INVENTION

This invention relates to access control for vehicles, buildings, rooms or other restricted areas or space and relates particularly to access control using keyless entry systems which use proximity detection to facilitate authorised entry past a lockable barrier to the area such as a vehicle.

The invention will be particularly described with reference to providing access to a motor vehicle. However, it should be appreciated that the invention has broader application and may be adapted for use in relation to access or entry, and locking of, any form of restricted area or space, including buildings, rooms, containers, equipment and the like. Accordingly, the following description should be read with the understanding that the invention is not limited to the particular applications described.

### BACKGROUND OF THE INVENTION

Various forms of access system are currently available which allow an authorised person access to a vehicle or restricted area. The most common access system is the use of a key in a lock. Actuation of the lock by the key from a locked to an unlocked position enables movement of a door handle to open the door. More recently, controlled access is provided, particularly to motor vehicles, using an access system which, in one form, includes a radio transmitter actuated by an authorised user. The transmitter may be a separate, easily portable transmitter unit or it may be housed in, for example, a key base or the like. Actuation of a push button on the transmitter causes a radio signal to be transmitted which, if the transmitter is within range, is received by an appropriate receiver in the vehicle. On reception of an appropriate authorising signal, one or more doors of the vehicle are unlocked.

In another proposed access system, an authorised person will carry a transceiver, and an access communications protocol is initiated whereby the transceiver is identified and authenticated by a receiver in the vehicle which then initiates an actuator to unlock one or more of the vehicle doors.

With the introduction of the so called “passive access” systems, with the portable control unit or transponder being read by electromagnetic means, there is no need for the authorised user to push a button or to insert a key into a lock in order to authorise the unlocking of the vehicle. In some systems, it is only necessary to carry the control unit or transponder in close proximity to the vehicle.

Such a passive access system, however, results in the vehicle being in an unlocked condition whenever the control unit or transponder is within range of the electromagnetic transmissions issuing from the vehicle and to which the control unit or transponder responds. With this arrangement, the vehicle must continually detect the presence of the control unit or transponder, which is usually associated with the vehicle ignition key. However this results in significant power consumption or the use of a second detection means that can detect the presence or absence of the control unit or transponder. Many situations occur, however, where the authorised user carrying the control unit or transponder may wish to approach or remain in the vehicle without the doors being unlocked.

In many instances, it is not desirable for the vehicle to activate an unlock or lock action on the sole basis of key proximity alone, as these actions should generally be user initiated actions. Thus, when a user is in the detection zone and does not wish to unlock the vehicle, it may be frustrating or irritating to the user if the door(s) is automatically unlocked.

It has been proposed to detect the proximity of a hand of a user to a handle on the door of the vehicle, or to detect a hand behind the handle or to detect the initial lifting of the handle which is necessary in order to gain entry to the vehicle. However, the time required for actuators to respond to such detection and unlock the door is too short without significant modification to the door latch and/or fitting of faster actuators.

Accordingly, it is therefore desirable to provide an improved access control for vehicles whereby the doors remain in a locked state until a predetermined action by the authorised user initiates unlocking.

It is also desirable to provide the user with a means to control either locking or unlocking of a vehicle when the key and therefore the user is within a detection zone of a passive access system used to authorise entry to the vehicle.

It is also desirable to provide an improved access control for vehicles which is simple and economical to incorporate in vehicles both during manufacture and as an after market fitting.

It is also desirable to provide a vehicle access control which is versatile in its programmability and functionality.

It is also desirable to provide an improved vehicle access control that is secure.

It is also desirable to provide a door locking and unlocking activation to be separate from a door locking or unlocking authorisation performed by a passive access system.

It is also desirable to provide deliberate access to the interior of a vehicle using a passive access system that allows simple retro fitting with minimal modification to current or already manufactured vehicles.

It is also desirable to provide locking of the vehicle doors in a reverse procedure to the unlocking of the vehicle doors when the user is within proximity or a detection zone of the passive access system.

### SUMMARY OF THE INVENTION

According to one aspect of the invention there is provided an access control system comprising a manually operable switch mounted on or adjacent access means controlling access to a restricted space, proximity detection means associated with said restricted space to detect the presence of at least one portable authorising control unit within a predetermined range of said space, and locking and unlocking means associated with said access means and operable on manual actuation of said switch and when said authorising control unit is detected by said proximity detection means to selectively lock or unlock said access means.

In one form of the invention, the system of the invention uses a switch associated with a vehicle door handle to initiate a communication protocol whereby the proximity detection means is initiated to determine the presence of an authorising control unit. In another, preferred, form of the invention, the proximity detection means regularly and/or periodically checks for the presence of an authorising control unit. With this arrangement, sensing of the presence of an authorising control unit causes the system to become responsive to the switch actuation.

With many current vehicles, the door handle has a lift plate which operates the door latching mechanism. In one embodiment of the invention, a switch is mounted adjacent the lift plate so that a push on the lift plate actuates the switch. Such a switch may then be used to initiate the communication protocol whereby a base station in the vehicle transmits an electromagnetic signal which is received by any control unit that may be within range. Such control units may include a transponder which receives the base station transmission and responds with a coded signal which identifies the individual control unit. When a control unit is authenticated, the base station causes the door locking mechanism to unlock so that lifting the lift plate then releases the door latching mechanism.

In a more preferred form of the invention, a base station in the vehicle transmits either a continuous or a periodic electromagnetic signal with a restricted, predetermined range, such as from 0.5 metres to 15 meters. If a control unit is within the range, a transponder associated with the control unit transmits a signal in response to the base station signal, the response signal including a code that is identified and authenticated by the base station. Once an authorised control unit is sensed in proximity to the vehicle, the base station enables the door locking system so that actuation of the manually operable switch causes the selected vehicle door(s) to be unlocked.

It will be appreciated that by incorporating a push switch into the mechanism of the door handle, the door lock and unlock activation is separated from the door lock/unlock authorisation, which is carried out passively. The unlock activation is part of the door opening process whereby a push on the handle causes the door to become unlocked and the lifting of the handle gains access to the vehicle.

Preferably, the door locking activation is also carried out by means of pushing the door handle. Thus, in one embodiment, when the door is closed and latched, the “push” on the handle causes the door to become locked even though the control unit is still within transmission range of the base station.

It will be understood that the base station can be programmed so that the vehicle door remains unlocked until the handle is pushed. However, it is also possible to program the base station such that the vehicle door is locked either by a push on the handle or after a predetermined time after the control unit moves away from the range of the base station signal transmissions.

In a further modification, the system of the invention may be programmed so that a door can be maintained in an unlocked condition following a double actuation of the switch, as by a double push on the handle, until some other predefined event occurs. Such an event could be a second double push on the handle, a reset of the system following starting of the vehicle, or the like.

According to another aspect of the invention there is provided apparatus to enable deliberate access to the interior of a vehicle that uses proximity detection of a key to authorise entry to the vehicle, the apparatus comprising:
switch means co-located with or adjacent to handle means of a door of the vehicle such that by activating the switch means the door is unlocked and access to the vehicle interior is gained by using the handle means.

Thus, with this particular arrangement, a user whose key to the vehicle is within a detection zone of the locking system of the vehicle authorises entry to the vehicle with the user providing control as to whether or not he or she wishes to unlock the door or doors via the operation of the switch means which may be close to the handle of the door or incorporated with a mechanism of the door handle. On depressing or activating the switch means and lifting or operating the door handle, access to the vehicle is obtained. Thus there may be a situations where a user has a purpose for being within close proximity to the vehicle but does not wish to enter the vehicle. The apparatus of this invention allows such a system to be maintained by keeping the doors locked until activated through the switch means by the user.

Preferably, the switch means of the apparatus is integral or incorporated with the door handle mechanism for unlocking or locking the door. Preferably activation of the switch means is performed by depressing or pushing the handle means thereby allowing the user to gain entry to the vehicle by lifting or otherwise operating the door handle means.

Preferably, activation of the door lock to the locked condition is also by means of activating the switch means such as by pushing the door handle means as part of a normal door closing operation.

According to a further aspect of the invention there is provided apparatus for facilitating entry to the interior of a vehicle that uses proximity detection of a key to authorise entry to the vehicle, the apparatus comprising:
handle means provided in a door of the vehicle; and
switch means formed integrally with or located adjacent the handle means;
   whereby detection of the key in proximity of the vehicle enables subsequent activation of the switch means to cause the vehicle door to be unlocked thereby enabling subsequently user actuation of the handle means to open the door. In order that the invention is more readily understood, embodiments thereof will now be described with reference to the accompanying drawings.

### DESCRIPTION OF THE DRAWINGS

FIG. 1 illustrates a vehicle door handle release mechanism incorporating a door switch in accordance with one embodiment of the invention; and

FIG. 2 is a cross sectional view of a door switch in accordance with one form of the invention.

FIG. 3 is a partial and enlarged view of part of a vehicle door illustrating a handle in accordance with a further embodiment of the invention.

### DESCRIPTION OF THE PREFERRED EMBODIMENTS OF THE INVENTION

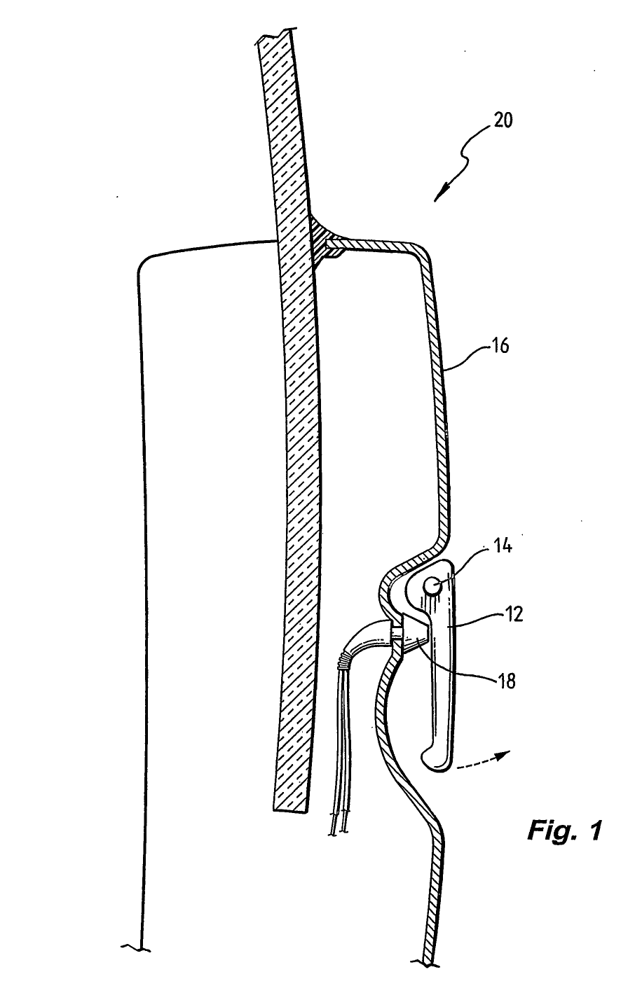

Referring to the drawings, there is shown in FIG. 1 a partial cross sectional view through a vehicle door 20 showing the door handle 12 which is pivoted at 14 so as to be lifted relative to the door skin 16. A latching and locking mechanism, which is well known in the art and will not be described in detail, is connected to the lifting plate 12 so that, when the door 20 is in an unlocked state, lifting of the plate 12 releases the door latch and enables the door to be swung open. When the lock is in the locked state lifting the plate 12 has no effect.

In accordance with the illustrated embodiment of the invention, a switch 18 is fitted to the door structure and contacts the rear side of the lifting plate 12. The switch 18 is constructed so that, when the plate 12 is pushed, rather than lifted, the switch is actuated. Actuation of the switch may give rise to one of two possible alternate system operations, according to how the system of the embodiment is programmed and set up.

In one arrangement, actuation of the switch 18 initiates a communication protocol whereby a base station in the vehicle (not shown) transmits an electromagnetic signal which is received by any control unit/transponder that is within range of the transmission. That range generally will be of the order of between 0.5 and 15 metres, although a greater or lesser range may be used in the performance of the invention.

Once a transponder responds to the signal, it transmits back to the base station a coded signal which, if authenticated, will cause the vehicle base station to initiate unlocking of the vehicle door 20 whereby lifting of the lift plate 12 will release the door latching mechanism.

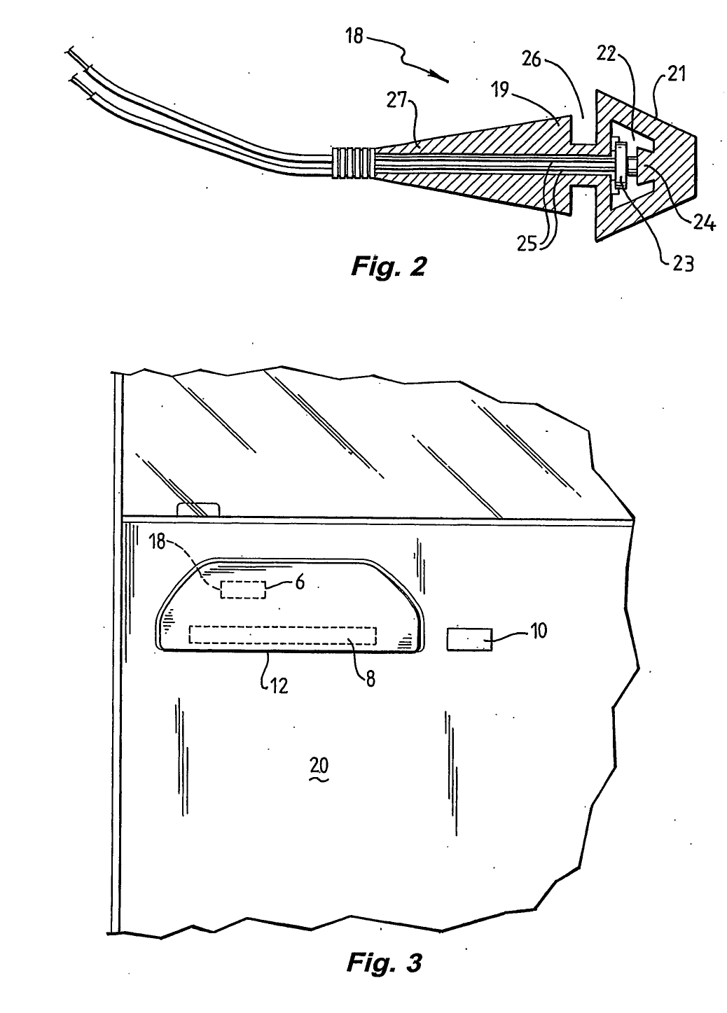

In a second arrangement, a communication protocol is in place whereby a base station in the vehicle transmits an electromagnetic signal on a regular or periodic basis, such as twenty times each second. If the transmitted signal is received by any control unit/transponder that comes within range of the transmission, the control unit will transmit a coded signal that is received and authenticated by the base station. Once authenticated, the base station will enable the unlocking circuitry so that actuation of the switch 18 by pressing the lift plate 12 will cause the door(s) to be unlocked and subsequent lifting of the lift plate 12 will release the door latching mechanism. The switch 18 may take the form of that shown in FIG. 2. The switch 18 incorporates a body 19 formed of a resilient material such as rubber, synthetic plastics material or the like. The body has a head 21 of frustroconical shape with a hollow chamber 22 in which is located the switch contacts 23. The contacts 23 are connected to a pair of electrical cables 25 extending through the body 19 and exiting at the rear end 27 thereof. The contacts 23, which are normally open, are closed by an actuating knob 24 formed as part of the head 21 and projecting into the chamber 22.

The body 19 has an annular channel 26 behind the head 21. The rear section 27 of the body tapers away from the channel 26. The switch 18 is adapted to be supported in a hole formed in a door panel 16, a bracket or other support structure, the support structure engaging in the channel 26 so that the head 21 projects towards and is contacted by the lift plate 12. Because of the resilient material from which the body 19 is formed, the head is able to be deformed so that the knob 24 closes the switch contact 23 when the lift plate 12 is pushed.

The switch may form the basis of a rubber stop for a door handle, either replacing an existing stop or as an adjunct. The rubber body 19 allows compression of the door handle for switch actuation.

By forming the switch in the form of a rubber stopper, similar to those currently fitted to the door handle, it is a simple matter to retrofit the switch in place of an existing rubber stopper to thereby fit the access control system of the invention to existing vehicles. The unlock activation of the vehicle door 20 becomes part of the door opening process by firstly pushing on the handle, waiting for the door 20 to unlock and then lifting the handle to gain access to the vehicle. The door lock may also be activated, or initiated, on exiting the vehicle, by pushing the door handle.

Referring to FIG. 3, there is shown a portion of a vehicle door 20 which is typically the door of the vehicle permitting entry by the driver. The door handle is a lift plate 12, and several different positions for locating the switch 18 are shown at 6, 8 and

When the switch 18 is incorporated with the mechanism of the door handle 12, such as positions 6 or 8, the switch 18 is preferably housed in a modified rubber stopper 19, such as referred to above, and that are similar to the stoppers currently fitted to the door handle and thus require no tooling change. The switches 6 or 8 may form part of the handle 12 such that a user presses the handle 12 to activate a lock or unlock condition. Alternatively, the switch 18 may be located adjacent the handle 4 such as in position 10 whereby a user first depresses the switch 18 to effect a lock or unlock condition and then uses the handle 12 to open or close the door 20. A modified rubber stopper may be used to house the switch 18 in position 10.

Where the door 20 is unlocked and requires locking, the user may push the handle 12 in order to activate the switch 18 to activates the mechanism of the door handle to lock the door and thereby secure the vehicle. In situations where the driver or user does not wish to lock the vehicle, the user will simply close the door without pressing on the handle or the switch 18.

This invention provides a particular advantage with regard to passive access systems where key in lock or push key transponders are not used. It provides control to the user to unlock or lock the door of the vehicle when an identifying control unit and transponder is within range of the proximity detection system. The doors do not automatically unlock when the transponder is in detection range as occurs with currently proposed passive access systems but only when the user activates a switch 18 in any of the positions 6, 8 or 10 or elsewhere.

Although embodiments of the invention have been described as using a lift plate door handle, it will be understood by those skilled in the art that the principals of the invention may be adapted to be used with any form of door handle, including push button door releases, pull handle releases, turn handles and any other similar form of latch release.

1. An access control system comprising a manually operable switch mounted on or adjacent access means controlling access to a restricted space, proximity detection means associated with said restricted space to detect the presence of at least one portable authorising control unit within an effective predetermined range of said space, and unlocking means associated with said access means and operable on manual actuation of said manually operable switch and when said portable authorising control unit is detected by said proximity detection means to unlock said access means.

2. An access control system according to claim 1 wherein said restricted space is a motor vehicle and said access means comprises a vehicle door.

3. An access control system according to claim 1 wherein said authorizing control unit includes a transponder that responds, when in range, to predetermined electromagnetic signals transmitted by said proximity detection means to transmit a coded signal to the proximity detection means.

4. An access control system according to claim 1 wherein said proximity detection means includes decoding means to authenticate coded signal from the control unit whereupon unlocking of said access control is initiated.

5. An access control system according to claim 1 wherein the manually operable switch is associated with a vehicle door handle to initiate a communication protocol whereby the proximity detection means is initiated to determine the presence of an authorising control unit.

6. An access control system according to claim 1 wherein the proximity detection means regularly and/or periodically checks for the presence of an authorising control unit.

7. An access control system according to claim 6 wherein sensing of the presence of an authorising control unit causes the system to become responsive to the manual actuation of the switch.

8. An access control system according to claim 1 wherein the access means includes a door with a door handle which operates a door latching mechanism.

9. An access control system according to claim 8 wherein the door handle is in the form of a lift plate which operates the door latching mechanism by lifting, and said manually operable switch is mounted adjacent the lift plate such that a push on the lift plate actuates the switch.

10. An access control system according to claim 2 wherein the manually operable switch is used to initiate a communication protocol whereby a base station in the vehicle transmits an electromagnetic signal which is able to be received by any control unit that may be within range, said control unit including a transponder which responds with a coded signal identifying the control unit.

11. An access control system according to claim 10 wherein, when a control unit is authenticated, the base station causes the door locking mechanism to unlock so that lifting the lift plate then releases the door latching mechanism.

12. An access control system according to claim 1 wherein a base station in the vehicle transmits either a continuous or a periodic electromagnetic signal with an effective range of between 0.5 and 15 metres.

13. An access control system according to claim 1 wherein locking an unlocked access means is effected by the manual actuation of said manually operable switch actuation.

14. An access control system according to claim 1 wherein locking an unlocked access means is effected by the manual actuation of said manually operable switch while said authorizing control unit is within said predetermined range of said space.

15. An access control system according to claim 8 wherein when the door is closed and latched, movement of the door handle in a direction opposite to that that would cause the door to be unlatched causes the door to become locked.

16. An access control system according to claim 15 including a base station that is programmed so that the door remains unlocked until the handle is moved in said opposite direction.

17. An access control system according to claim 16 wherein the base station is programmed such that the vehicle door is locked either by a movement of the handle in said opposite direction or after a predetermined time after the control unit is no longer within said effective range of the base station signal transmissions.

18. An access control system according to claim 1 wherein said unlocking means maintains the access means in an unlocked condition following two actuations of said manually operable switch within a predetermined period and until another predefined event.

19. Apparatus to enable access to the interior of a vehicle that uses proximity detection means to detect the presence of a control unit to authorise entry to the vehicle, the apparatus comprising switch means co-located with or adjacent door handle mechanism for locking or unlocking the door of the vehicle such that, on detection by the proximity detection means of the presence of an authorising control unit within a predetermined range of the vehicle, activation of the switch means causes the door to be unlocked facilitating access to the vehicle interior.

20. Apparatus according to claim 19 wherein the switch means is integral or incorporated with the door handle mechanism for unlocking or locking the door.

21. Apparatus according to claim 19 wherein activation of the switch means is performed by depressing or pushing the handle means thereby allowing the user to gain entry to the vehicle by lifting or otherwise operating the door handle means to operate door unlatching means.

22. Apparatus according to any one of claim 19 wherein activation of the switch means when the door is in an unlocked condition causes the door to become locked.

23. Apparatus facilitating entry to the interior of a vehicle that uses proximity detection of a control unit to authorise entry to the vehicle, the apparatus comprising:
handle means provided in a door of the vehicle; and
switch means formed integrally with or located adjacent the handle means;
whereby detection of the control unit in proximity of the vehicle enables subsequent activation of the switch means to cause the vehicle door to be unlocked thereby enabling subsequently user actuation of the handle means to open the door.

24. (canceled)
